(19) United States
(12) Patent Application Publication
(10) Pub. No.: US 2023/0240201 A1
(43) Pub. Date: Aug. 3, 2023

(54) TRAY FOR HORTICULTURAL CONTAINERS

(71) Applicant: The HC Companies, Inc., Twinsburg, OH (US)

(72) Inventors: Christopher Justin ALCORN, Solon, OH (US); Margot Elizabeth BEESLEY, Akron, OH (US)

(21) Appl. No.: 18/151,067

(22) Filed: Jan. 6, 2023

Related U.S. Application Data
(60) Provisional application No. 63/305,903, filed on Feb. 2, 2022.

(51) Int. Cl. A01G 9/029; B65D 1/36; A01G 9/02

(52) U.S. Cl. CPC A01G 9/0297; B65D 1/36; A01G 9/027

(57) ABSTRACT

A tray for a horticultural container. The tray includes a plurality of walls forming an outer perimeter and a plurality of openings encompassed within the perimeter, each opening configured to accept a horticultural container. Each opening includes at least one tab configured to engage a portion of the horticultural container such that the horticultural container is held in place within one of the plurality of openings. The tray is configured to have a low profile to save space, save manufacturing materials, and to improve stacking capabilities. The tray can include a plurality of secondary openings to mitigate soil waste in a filling procedure.

### RELATED APPLICATIONS

This application claims the benefit of U.S. Provisional Application No. 63/305,903 filed Feb. 2, 2022, which is hereby incorporated herein by reference.

### TECHNICAL FIELD

The present disclosure relates generally to a device or a tray for storing or shipping products, such as plants or horticultural containers.

### BACKGROUND

Plants are often sold and shipped in pre-planted arrangements in horticultural containers, such as planters and hanging baskets. In many situations, plants are raised from seed in the containers or young plants are transplanted into the containers. Shipping trays can be provided to hold a plurality of horticultural containers during shipping or storage to allow for more effective transportation. The shipping trays can prevent the plants and the horticultural containers from tipping over and can allow for more organized shipping.

### SUMMARY OF INVENTION

The present application provides an improved tray for horticultural containers. The tray may reduce soil waste, may be more environmentally friendly, may have a reduced size and footprint, may have improved and consistent quality, and may have improved stacking capabilities compared to conventional trays. The tray can be referred to as a low profile tray when considering the reduced height and reduced surface area compared to conventional trays.

In an embodiment, a tray configured to hold a plurality of horticultural containers comprises a top surface and a bottom surface opposite the top surface, a plurality of outer walls forming an outer perimeter, a plurality of openings enclosed within the outer perimeter and extending from the top of the tray to the bottom of the tray, and a plurality of hoops forming the plurality of openings, the plurality of hoops are encompassed within the outer perimeter and affixed to at least one of the plurality of outer walls, each of the plurality of openings defined by a respective hoop of the tray such that each respective hoop is configured to accept and retain a single one of the plurality of horticultural containers, and wherein each of the hoops comprises at least one first tab, each first tab configured to engage a surface of a respective horticultural container to hold the respective horticultural container within a respective opening that is defined by a respective hoop.

In an embodiment, each first tab comprises a clip at a distal end, the clip extends in a direction towards a center of the respective opening, the clip is configured to engage a top surface of a rim of the respective horticultural container to prevent upward movement of the respective horticultural container with respect to the tray.

In an embodiment, at least a portion of each first tab is configured to flex between a locked and an unlocked position, each first tab configured to engage the rim of the respective horticultural container when in the locked position and configured to disengage the rim of the respective horticultural container when in the unlocked position.

In an embodiment, each first tab is biased in the locked position.

In an embodiment, each of the hoops further comprise at least one second tab, the second tabs different from the first tabs, each second tab configured to engage a second surface of a respective horticultural container to hold the respective horticultural container in a position relative to the tray.

In an embodiment, each second tab comprises a first portion extending perpendicular and upward from a top surface of the tray such that the first portion is configured to engage a bottom surface of the rim of a respective horticultural container to support the respective horticultural container in a respective hoop, wherein the first portion mitigates movement of the respective horticultural container in a downward direction.

In an embodiment, each second tab comprises a second portion extending radially-inward from each second tab in a direction towards the center of a respective opening, the second portion configured to engage an outer surface of a respective horticultural container to prevent movement of the respective horticultural container with respect to the tray.

In an embodiment, each second tab holds the plurality of horticultural containers within the pluralities of hoops by way of pressure fit.

In an embodiment, the tray is configured to allow for stacking with at least one other tray of similar dimensions to the first tray.

In an embodiment, the plurality of hoops are configured to match a corresponding shape and size of the plurality of horticultural containers.

In an embodiment, the plurality of hoops are circular.

In an embodiment, the tray further comprises a plurality of secondary openings extending from the top surface to the bottom surface, the plurality of secondary openings configured to reduce soil waste by allowing soil not inserted into the horticultural container during filling of the horticultural container to pass through the secondary opening.

In an embodiment, a tray and horticultural container assembly, comprises the tray described herein, and a plurality of horticultural containers, each of the plurality of horticultural containers inserted into a corresponding single one of the plurality of openings of the tray.

In an embodiment, the assembly further comprises a second tray wherein the first tray and the second tray are stacked one over another and the plurality of horticultural containers of each of the first tray and the second tray are configured such that corresponding feature of the plurality of horticultural containers nest within one another.

In an embodiment, a tray configured to hold a plurality of horticultural containers comprises a plurality of hoops defining a plurality of openings, the plurality of hoops are affixed to one another, each of the plurality of openings defined by a respective hoop of the tray such that each respective hoop is configured to accept and retain a single one of the plurality of horticultural containers, wherein each of the hoops comprise at least one a first tab, each first tab configured to engage a top surface of a rim of a respective horticultural container to mitigate upward movement of the respective horticultural container with respect to the tray and wherein each of the hoops comprise a at least one second tab, each second tab configured to engage a side surface of the respective horticultural container to mitigate lateral movement and to engage a bottom surface of a rim of the respective horticultural container to mitigate downward movement of the respective horticultural container with respect to the tray.

In an embodiment, each first tab comprises a clip at a distal end, the clip extends in a direction towards a center of a respective opening, the clip is configured to engage the top surface of the rim of the respective horticultural container.

In an embodiment, at least a portion of each first tab is configured to flex between a locked and an unlocked position, each first tab configured to engage the top surface of the rim of the respective horticultural container when in the locked position and configured to disengage the rim of the respective horticultural container when in the unlocked position.

In an embodiment, each second tab comprises a first portion extending perpendicular from a top surface of the tray such that the first portion is configured to engage a bottom surface of the rim of the respective horticultural container to support the respective horticultural container in a respective hoop, wherein the first portion of each second tab mitigates movement of the respective horticultural container in a downward direction.

In an embodiment, each second tab comprises a second portion extending radially-inward from each second tab in a direction towards the center of a respective opening, the second portion configured to engage an outer surface of a respective horticultural container to prevent movement of the respective horticultural container with respect to the tray.

In an embodiment, the plurality of hoops are configured to match a corresponding shape and size of the plurality of horticultural containers and the tray is configured to allow for stacking with at least one other tray of similar dimensions to the first tray.

In an embodiment, a tray for horticultural containers comprises a top surface and a bottom surface opposite the top surface, a plurality of outer walls forming an outer perimeter, and a plurality of openings enclosed within the outer perimeter, wherein the plurality of openings extend from the top of the tray to the bottom of the tray, the plurality of openings each configured to accept and retain a single one of the horticultural containers with a portion of the horticultural container above the tray and a portion of the horticultural container below the tray.

In an embodiment, each opening formed by a hoop of material of the tray.

In an embodiment, each hoop has one or more tabs configured to engage a surface of the horticultural container to hold the horticultural container in the opening relative to the tray.

In an embodiment, the tray further comprises a plurality of second tabs different from the plurality of first tabs, the plurality of second tabs configured to engage a second surface of the horticultural containers to hold the horticultural containers in a position relative to the tray.

In an embodiment, the plurality of first tabs and the plurality of second tabs hold the horticultural containers in the position by way of pressure fit. The foregoing and other features will be described in greater detail with reference to the accompanying drawings.

### BRIEF DESCRIPTION OF THE DRAWINGS

FIG. 1 is a perspective view of an exemplary tray for one or more horticultural containers.

FIG. 2 is a cross-sectional view of an exemplary horticultural container.

FIG. 3 is a fragmentary perspective view of a portion of the tray for one or more horticultural containers.

FIG. 4 is a fragmentary view of the tray and a portion of the horticultural container.

FIG. 5 is a fragmentary cross-sectional view showing the tray and a portion of a horticultural container.

FIG. 6 is a perspective view of the tray for one or more horticultural containers.

FIG. 7 is a top plan view of the tray for one or more horticultural containers.

FIG. 8 is a perspective view of another exemplary tray for one or more horticultural containers.

FIG. 9 is a fragmentary perspective view of a portion of the tray for one or more horticultural containers.

FIG. 10 is a fragmentary cross-sectional view showing the tray and a portion of a horticultural container.

FIG. 11 is another fragmentary cross-sectional view showing the tray and a portion of a horticultural container.

FIG. 12 is a top view of the tray for one or more horticultural containers.

FIG. 13 is a top view of a portion of the tray for one or more horticultural containers.

FIG. 14 is a perspective view showing more than one tray with containers stacked on top of one another.

FIG. 15 is a top view of a plurality of trays.

FIG. 16 is a perspective view of another exemplary tray for one or more horticultural containers.

FIG. 17 is a cross-sectional view of the tray for one or more horticultural containers.

FIG. 18 is a cross-sectional view showing the tray and a portion of a horticultural container.

FIG. 19 is a top view of a plurality of trays.

### DETAILED DESCRIPTION

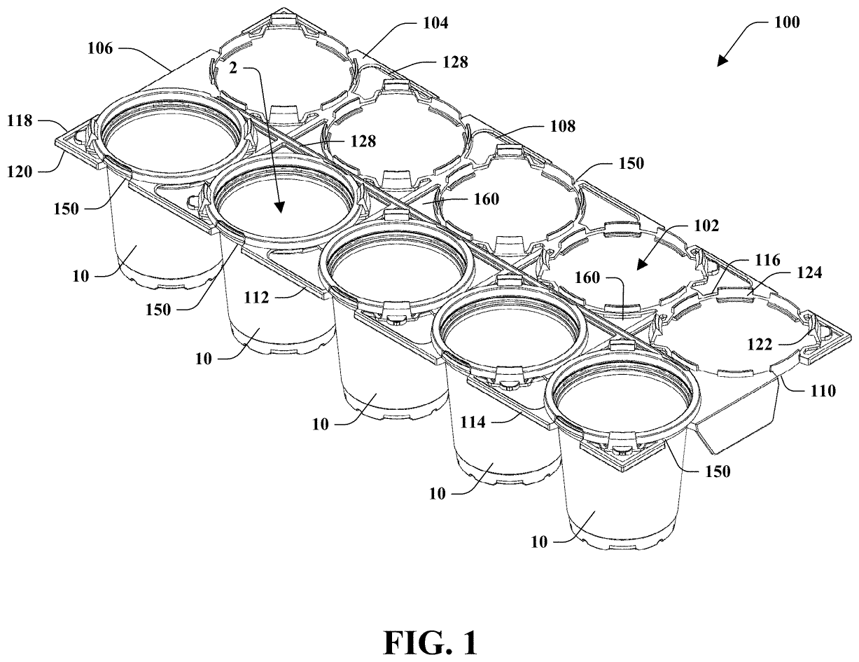

Turning now to FIG. 1, a tray 100 for one or more horticultural containers 10 is shown. The tray 100 can include a plurality of openings 102. Each opening 102 may hold a respective horticultural container 10 (also referred to as a planter 10). Namely, a planter 10 can be placed in a respective opening 102 and held in place by a portion of the tray 100. The tray 100 comprises ten openings 102 such that the tray 100 is capable of holding ten planters 10. Although illustrated with ten openings 102, it should be appreciated that the tray 100 can be configured in any shape with any suitable number of openings 102 such that the tray 100 can hold any number of planters 10.

In one embodiment, the planter 10 is a thin-walled and light-weight planter made by thermoforming of plastic material, injection molding, casting, blow molding, or other suitable manufacturing processes. The tray 100 may be of heavier gauge than the planter 10 and may be formed, for example, by injection molding of plastic material. Other materials for the planter 10 or the tray 100 may be used. For instance, the planter 10 may be made of fiber-based or pulp-based material, and the tray 100 may be made of a suitable metal, ceramic, polymer, or carbon fiber material. The tray 100 may be manufactured such that it is strong enough to hold the planters 10 during the various activities and circumstances described in this disclosure. The tray 100 may also be manufactured such that it is not so rigid and/or brittle to crack when subjected to lateral and/or torsional forces expected during those activities and circumstances. In other words, the tray 100 can be strong enough to hold the planters 10, yet flexible enough that the tray 100 does not snap or break under pressure. The tray 100 can further be light-weight and thin enough to ensure that the tray(s) 100 can be transported and stored efficiently.

The tray 100 can include a body 104 containing the plurality of openings 102. The body 104 can be formed by a plurality of walls 106, 108, 110, 112, forming and an outer perimeter 114. The openings 102 can be enclosed within the outer perimeter 114 and can be further defined by a plurality of rings or hoops 116. Each of the plurality of hoops 116 can define an opening 102 that extends from a top 118 to a bottom 120 of the tray 100. The hoops 116 may be formed, in part, by one or more adjacent side walls 106, 108, 110, 112 of the tray 100 and/or in part by hoop elements connected to one or more of the side walls 106, 108, 110, 112. The hoop elements (or parts thereof) may be directly connected to the side walls 106, 108, 110, 112 or intermediate elements may connect the hoop elements (or parts thereof) to the side walls 106, 108, 110, 112.

The tray 100 may include additional strength members 128 that interconnect various parts of the tray 100. The tray 100 may be of monolithic construction, or may be formed in parts that are assembled such as with snap fits, adhesive, welding, or other suitable joining techniques. Each hoop 116 may completely inscribe the respective planter 10 or there may be a gap in one or more of the hoops 116 so that the hoop 116 partially inscribes the respective planter 10. In either of these cases, the hoop 116 may be slightly smaller than the area of the planter 10 that is to be placed within the openings 102. The hoop 116 may be flexible or elastic and/or may include a flexible or elastic element to assist in retaining the respective planter 10 by a compressive force.

The hoops 116 can include a plurality of tabs 122 and 124 that may hold the planters 10 in place. By way of example, the plurality of flexible and/or resilient tabs 122 and 124 can hold the planters 10 in the openings 102 by way of snap fit, pressure fit, friction fit, interference fit, latching, hooking, or the like. It may be desirable to hold the planters 10 in place (e.g., kept from moving relative to the tray 100 or kept from separating from the tray 100 until intentional action by a person is taken to remove the planter 10) so that the planters 10 can be transported or stored in the tray 100 without shifting or tipping during movement of the tray 100.

Also, engagement of the planter 10 and the tray 100 may be configured to avoid separating of the planter 10 from the tray 100 during processing by a grower and other activities, including when lateral and/or torsional forces from these activities are applied to the tray 100. For instance, when a tray 100 with associated planters 10 is removed from a stack of trays and planters, the planters 10 will tend not to separate from the tray 100. Similarly, during manual filling of the planter 10 with a growing medium (e.g., soil) by a worker and/or during automated filling of the planter 10 with the growing medium by automated filling equipment, which may subject the planter 10 to force by brushes, soil levelers, and/or compressed air, the planters 10 will tend not to separate from the tray 100. Also, during planting of seeds and/or transplanting of plants into the planters 10, the planters 10 will tend not to separate from the tray 100. The planters 10 also will tend not to separate from the tray 100 during subsequent handling, such as during shipment or during handling at a retail location where the planters 10 are sold.

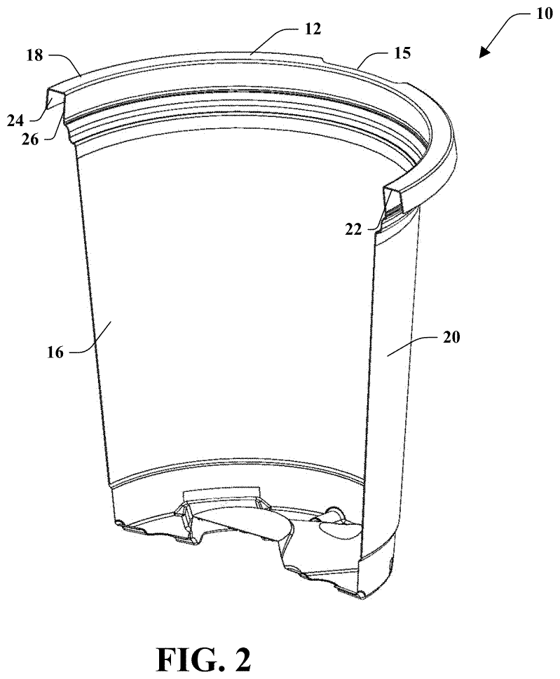

As illustrated in FIG. 2, the planters 10 can include an opened top 12, a closed bottom 14, and a body 16 extending from the top 12 to the bottom 14. Although the planter 10 is illustrated as being round in shape, the planter 10 can be any suitable shape or size. For instance, the planter 10 can be round, square, an oval, a hexagon, can have rounded edges, concave walls, convex walls, or can be any suitable shape. It should be appreciated that the hoops 116 can be configured to match the shape of the respective planter 10. Although the hoops 116 are illustrated as circular in shape to match corresponding circular planters 10, it should be appreciated that the hoops 116 can be any suitable size or shape. For instance, the hoop 116 can be oval-shaped to account for an oval-shaped planter 10, or can be square-shaped to account for a square planter 10.

The planter 10 can include a rim 18 proximate the top 12 of the planter 10 that extends radially outward from a surface 20 of the sidewalls of the planter forming the body 16. Said differently, the rim 18 can have a diameter wider than the diameter of the body 16 such that the rim 18 extends outwardly from the body 16 of the planter 10. In this manner, the planter 10 can be placed within a respective opening 102 by installing the planter 10 from the top of the tray 100 in a direction marked by arrow 2 (FIG. 1). The openings 102 can be large enough to accommodate the body 16 of the planter 10. The rim 18 of the planter 10, however, may be a suitable diameter such that the rim 18 of the planter 10 rests on a top surface 126 of the tab 122 or of the hoop 116. The rim 18 further includes an inner surface 22, and outer wall 24, and an inner wall 26. These features may engage with corresponding features of the tray 100 as described below.

In an embodiment shown in FIGS. 1-7, the rings/hoops 116 of the tray 100 can be configured with a tag slot opening 150. The tag slot opening 150 may take the form of a relief in the hoop 116 adjacent the tag slot 15 of the planter 10 or a smaller cross-sectional size of the hoop 116 adjacent the tag slot 15 of the planter 10. The tag slot opening 150 can be configured to align with a corresponding tag slot 15 of a corresponding planter 10. A tag slot 15 for the planter 10 can be designed for receiving and holding a display tag that hangs from the upper rim 12 of the planter 10.

The tag slot opening 150 can be configured to accommodate features of the tag slot 15 of the planter 10 and/or the tag so that the planter 10 with the tag can be inserted into the tray 100 or the tag may be inserted into the planter's 10 tag slot 15 after the planter 10 is inserted into the tray 100. For instance, the tag slot 15 of the planter 10 can be aligned with the tag slot opening 150 of the tray 100 so that the planter 10 adequately fits into the opening 102. The tag slot 15 and corresponding tag slot opening 150 can also prevent the planter 10 from rotating relative to the tray 100. In one embodiment, the tag slot and the tag slot opening 150 face an adjacent perimeter wall 106, 108, 110, 212 of the tray 100 so that the tag is visible to an observer or a scanning device. In one embodiment, the planter 10 has a through opening (e.g., a second tag slot 15) and the tray 100 has an upwardly projecting member that fits into the opening to reduce movement of the planter 10 relative to the tray 100.

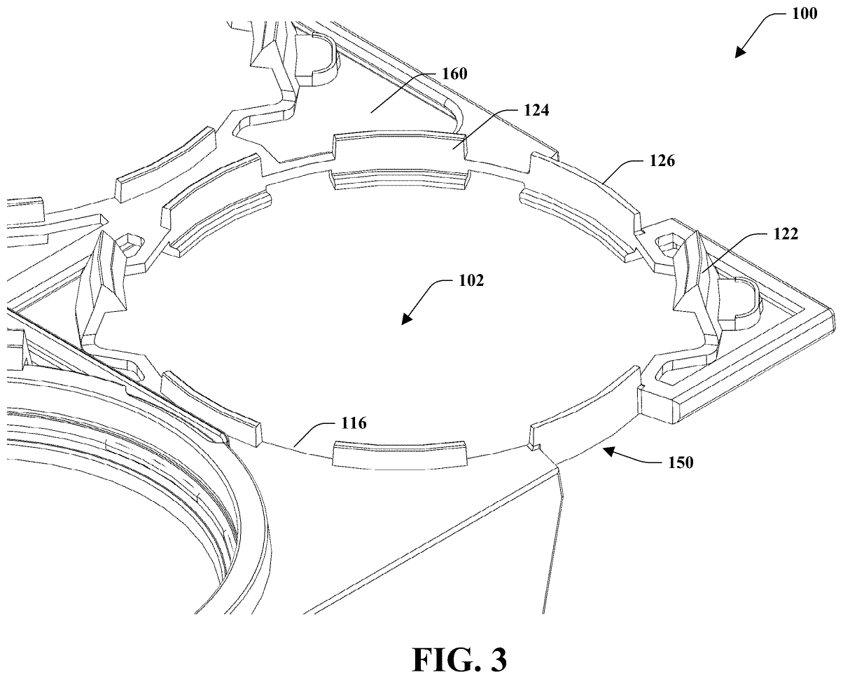

Turning to FIGS. 3-5, additional views of the tabs 122 and 124 are shown. In an example, the tabs 122 and 124 can be engineered (e.g., deliberately arranged, configured, adapted, and/or designed) to engage the rim 18 of the planter 10 and/or the sidewall/body 16 of the planter 10 such that the planter 10 is held in a static position between the tabs 122 and 124 (e.g., so that the planter 10 has a fixed relationship with the tray 100). In other examples, the tabs 122 and 124 are configured to engage different portions of the planter 10 to hold the planter 10 in a static position within the openings 102 or the hoop 116. It should be appreciated that the tabs 122 and 124 can be engineered based on the planter's 10 configuration. In certain embodiments, the tray 100 can have only the tabs 122, only the tabs 124, or can contain any type of suitable tabs. Additionally, the tray 100, and specifically, the hoops 116, can be configured with any number of the tabs 122 or 124 without deviating from the scope of the application.

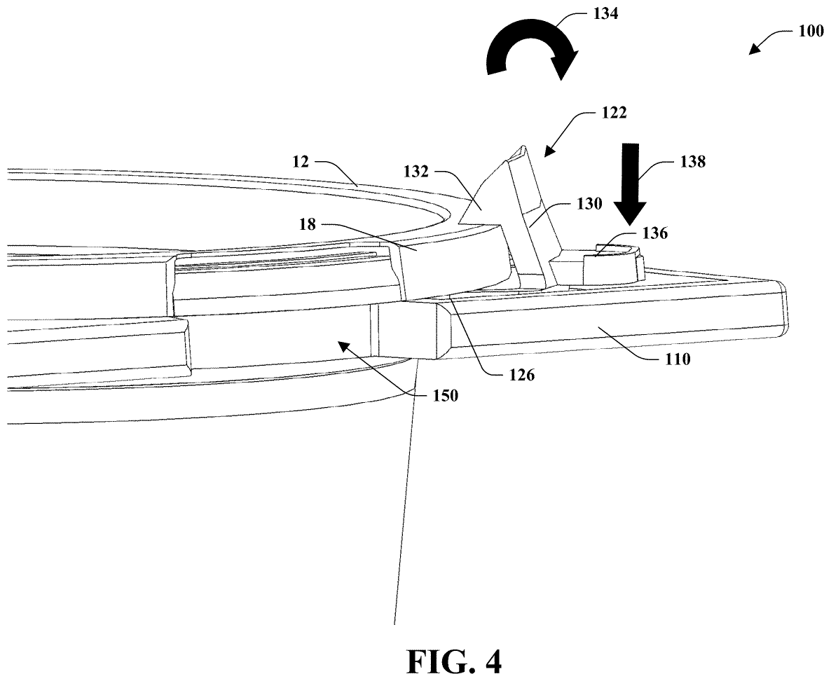

FIG. 4 is a close up perspective view showing the interaction of the tab 122 and corresponding portions of the planter 10. The tab 122 can include a portion 130 that is angled with respect to a top surface 126 of the hoop 116. The portion 130 can extend, at an angle, upward from the top 118 of the tray 100 and may extend over the rim 18 or the top 12 of the planter 10. The portion 130 can also extend radially inward from the hoop 116 in a direction toward the rim 18 of the planter 10 to hold the planter 10 in a position by way of latching or pressure fit, for example. To facilitate latching, the tab 122 can include a clip 132 that extends radially inward from the portion 130 in a direction toward the rim 18 of the planter 10. The clip 132 can engage the top 12 of the planter 10 or the rim 18 of the planter 10 to hold the planter 10 in a position within the hoop 116 (e.g., trap the planter 10 between a portion of the tab 122 and the top surface 126 of the tray 100). The rim 18 of the planter can extend outward from the body 16 or the surface 20 of the planter 10 and can engage a top surface 126 of the hoop 116 to prevent downward movement of the planter 10. Also, the resistance of the clip 132 or the distal end of the tab 122 against the planter 10 may reduce or mitigate upward movement of the planter 10 relative to the tray 100.

In an embodiment, the tab 122 is flexible and/or movable with respect to the tray 100 to facilitate installation and/or removal of a planter 10 from the tray 100. The tab 122 can also include a feature 136 that may be pressed by a user's finger to rotate and/or flex the tab 122 in the direction 134, for example. Specifically, the feature 136 may be pressed in direction 138 to move/rotate the tab 122 in the direction 134. It should be appreciated that the tab 122 can move/rotate in the direction 134 such that the clip 132 is no longer engaged with the rim 18 of the planter 10. The tab 122 can also be flexed/rotated so that no portion of the clip 132 is located above the rim 18 of the planter 10 so that the planter 10 may be removed from the tray 100. In other words, the tab 122 is no longer located above the rim 18 to prevent upward movement of the planter 10. Thus, when the tab 122 is flex/rotated in direction 134, the planter 10 can be lifted up and out of the tray 100. It should be appreciated that the tab 122 may be manufactured from a suitable material or may be configured to return to the position illustrated in FIG. 4 upon the release of the feature 136.

In an embodiment, the tabs 122 can be configured to rotate/flex between at least two positions. In a first position, sometimes referred to as a locked position, the tabs 122 can engage a surface of the rim 18 to mitigate upward movement of the planter 10. In a second position, sometimes referred to as an unlocked position, the tabs 122 can be sufficiently flexed such that the planter 10 can be removed from the tray 100 using an upward movement. It should be appreciated that the tabs 122 can be rotated or flexed between any number of positions and that the first and the second position are used herein as an example. The drawings, as illustrated, show the tabs 122 in a first or a locked position.

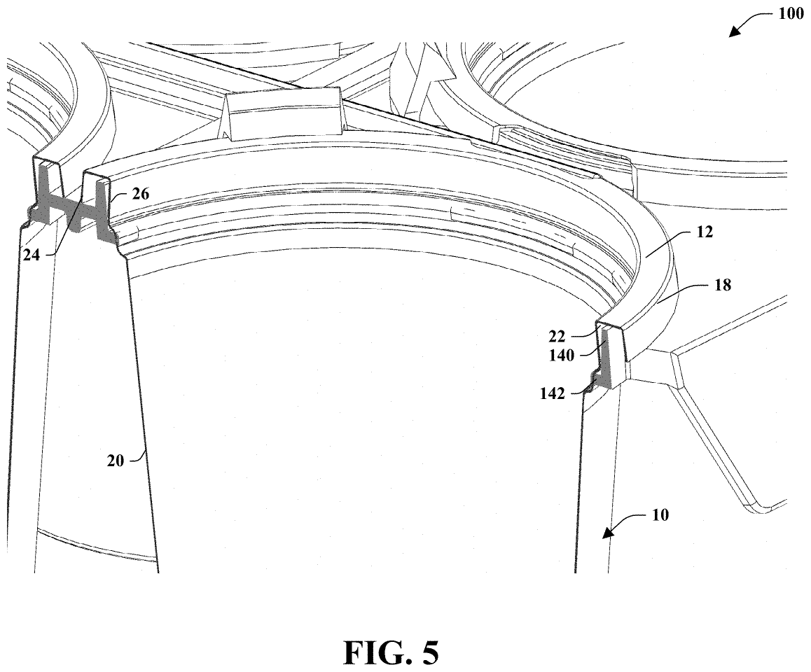

FIG. 5 is a close up cross-sectional view showing the interaction of tab 124 and corresponding portions of the planter 10. The tab 124 can include an upward-facing portion 140 and a radially-extending portion 142. The upward-facing portion 140 can extend upward and perpendicular from the top 118 of the tray 100 (or extends upward from another portion of the hoop 116). In other embodiments, the portion 140 can extend at an angle toward the surface 20 of the planter 10 to hold the planter 10 in a position by way of pressure fit, for example. Yet, in other embodiments, the portion 140 may extend at an angle away from the surface of the planter 10. The portion 140 can be configured to engage a bottom surface 22 of the rim 18 to hold the planter 10 within the tray 100 and to prevent downward movement of the planter 10. In this manner, the portion 140 can serve as a suitable seat to which the surface 22 of the rim 18 may rest. Additionally, the portion 140 may engage with or prevent lateral movement of the planter 10 by engaging the outer side wall 24 and/or the inner side wall 26 of the rim 18.

The radially-extending portion 142 may extend radially inward from the hoop 116 towards the surface 20 of the planter 10 in a direction parallel to the top surface 118 of the tray 100. The portion 142 may engage with the surface 20 of the planter 10, the inner surface 22 of the rim 18, or any other surface of the planter 10 between the rim 18 and the body 16. The portion 142 may limit or prevent downward movement of the planter 10. The portion 142 may also limit or prevent lateral movement of the planter 10 by way of pressure fit or friction. Similarly, in this regard, rotation of the planter 10 may be limited or prevented by one or both of the upward-facing portion 140 and/or the radially-extending portion 142.

In an embodiment, the various portions of the tab 122 and the tab 124 can flex a suitable amount to allow for removal and installation of the planter 10 in the openings 102 of the tray 100, and trap the planter 10 in the tray 100 when the planter 10 is installed therein. The suitable flex can provide a pressure fit or a friction fit to hold the planter 10 in a fixed position relative to the tray 100. In other embodiments, the planter 10 and the tray 100 may have cooperating elements (e.g., some combination of holes, apertures, indents, clips, notches, detents, etc., including or different from the tabs 122/124) to establish a snap fit or an interference fit. This arrangement can allow the planters 10 to be removeably inserted and removed from the tray 100 by a suitable force or pressure. Such suitable pressure may be one or both of upward pressure on the planter 10 relative to the tray 100 or inward radial pressure on the planter 10. The tabs 122 and 124 can be configured such that the tabs 122 and 124 hold the planter 10 in a fixed or static location respective to the tray 100 during transport or shipping of the planters 10. The tabs 122 and 124 can also be configured such that the planters 10 can be removed from the tray 100 with a suitable upward force (e.g., a user can lift the planters 10 out of the tray 100). It should be appreciated that the tabs 122 and 124 can be configured to allow for installation and removal of the planters 10.

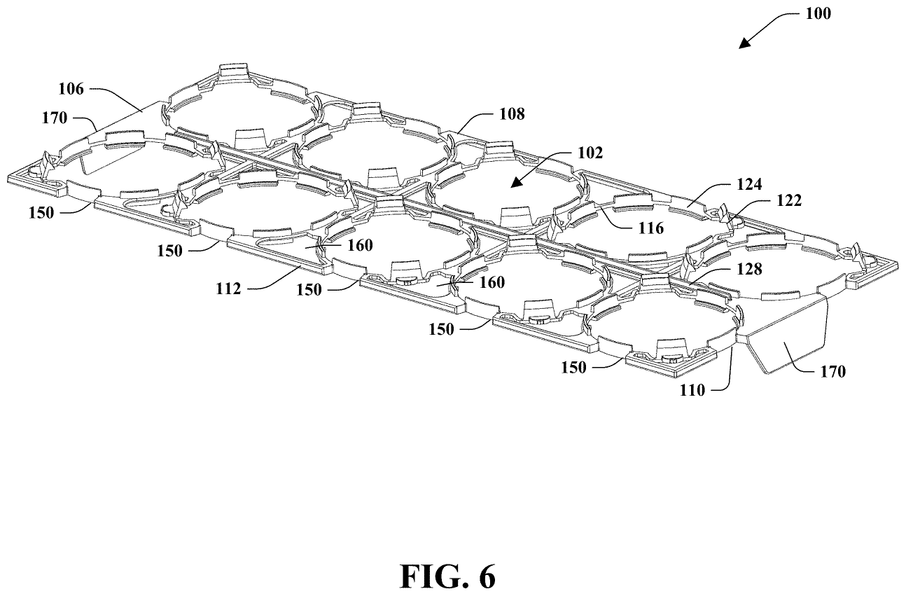

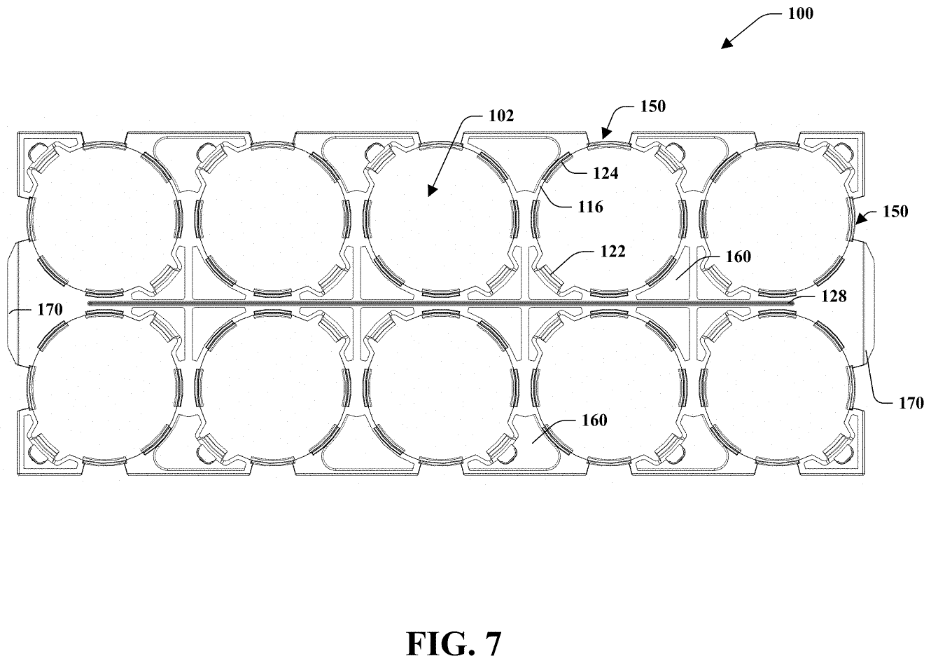

Turning to FIGS. 6 and 7, the tray 100 is shown without planters 10. The tray 100 can include at least one label surface 170. The label surface 170 can be located in any suitable location on the tray 100, such as the first side wall 106, the second side wall 108, the third side wall 110, or the fourth side wall 112. In the embodiment illustrated in the figures, the tray 100 includes a label surface 170 on the first side wall 106 and the third side wall 110. The label surface 170 may extend in a suitable direction from any of the side walls to serve at a location to affix a tag or label identifying a product within the tray 100. For example, the tray 100 may be used to transport planters 10 containing planted flowers. A label may be affixed to the label surface 170 to identify the type of flower.

The tray 100 can also include a plurality of secondary through openings 160 that extend from the top 118 to the bottom 120 of the tray 100. The secondary openings 160 can reduce the total surface area of the top surface 118 of the tray 100. A reduced surface area, caused in part from the secondary openings 160, can reduce an amount of soil that gets caught on the tray 100 (e.g., resulting in leftover or wasted soil).

In an example, the tray 100 is fitted with planters 10. The tray 100 is sent through an automation process in which soil is deposited into a cavity of the planters 10. In other words, the planters 10 are filled with soil. This process, however, may result in at least a portion of the soil remaining on the top surface of a conventional planter tray (i.e., not within the planter 10). This can be caused in part from inaccurate filling mechanisms, movement of the tray on a conveyor, overfilling, or similar issues. These issues can lead to wasted soil or can make soil recovery procedures difficult and time consuming.

The tray 100, configured with secondary openings 160, can reduce the amount of soil that is caught on the top surface of the tray 100. For instance, the soil can fall through the secondary openings 160 to a surface or conveyor belt below the tray 100 rather than getting caught on the tray 100. Those familiar with similar conveyor filling processes will readily appreciate the benefits of the tray 100. By way of example, recovering soil from a conveyor, a surface below the conveyor, or a collection bin can be more efficient and more easily accomplished compared to recovering soil from tray surfaces surrounding the planters as found with conventional planter trays. The reduced soil loss and time saved can result in a more cost effective filling operation.

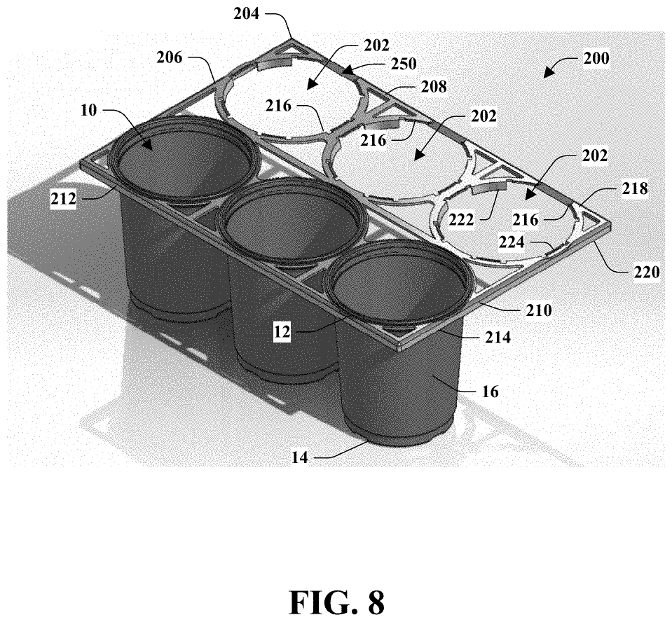

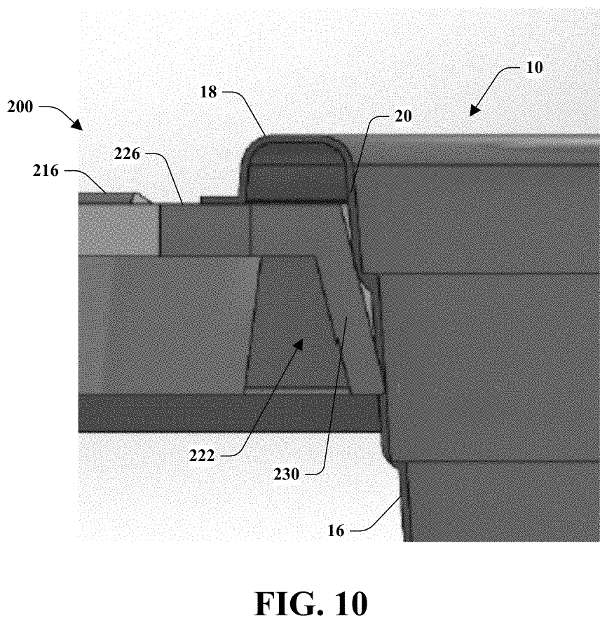

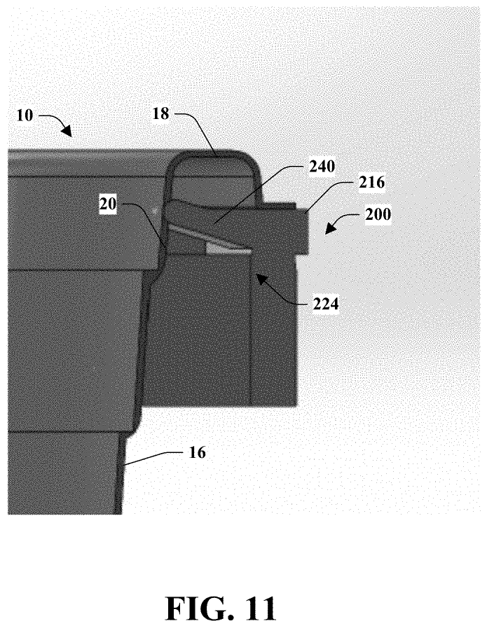

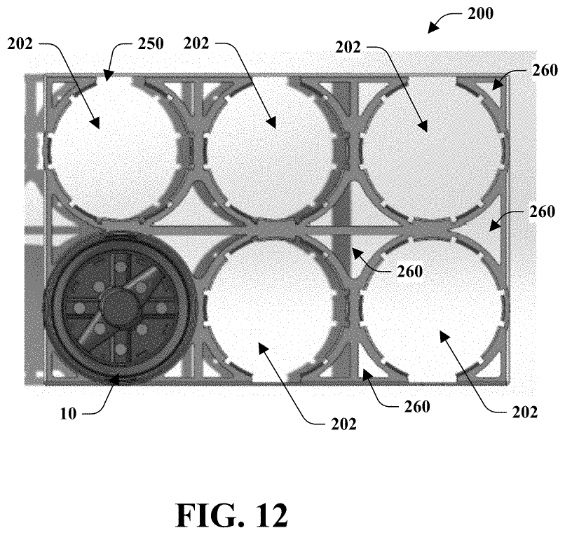

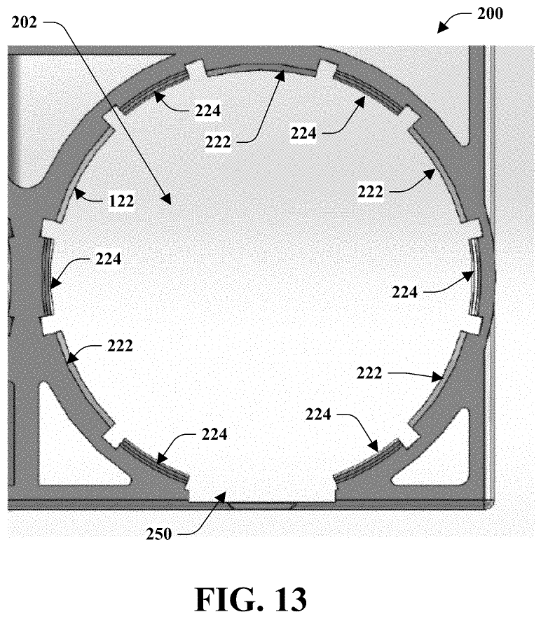

Turning to FIGS. 8-15, a second tray 200 for a horticultural container 10 is shown. The tray 200 is similar to the above-referenced tray 100, and consequently the same reference numerals but indexed by 100 are used to denote structures corresponding to similar structures in the trays. The foregoing description of the tray 100 is equally applicable to the tray 200 except as noted herein. Similarly, the description provided herein for tray 200 may be applicable for the tray 100 as well.

The tray 200 is shown with a single planter 10 installed within one of the plurality of openings 202. The tray 200 is illustrated having six openings 202, each configured to hold a planter 10. It should be appreciated, however, that that tray 200 can be configured with any number of openings 202 to hold any number of suitable planters 10. For instance, the tray 200 can be configured with four openings 202, ten openings 202, seven openings 202, twelve openings 202, or any other suitable number as required. The openings 202 may be arranged in a single row, two rows, or three or more rows. If in multiple rows, the openings 202 may be arranged in columns or have a staggered arrangement.

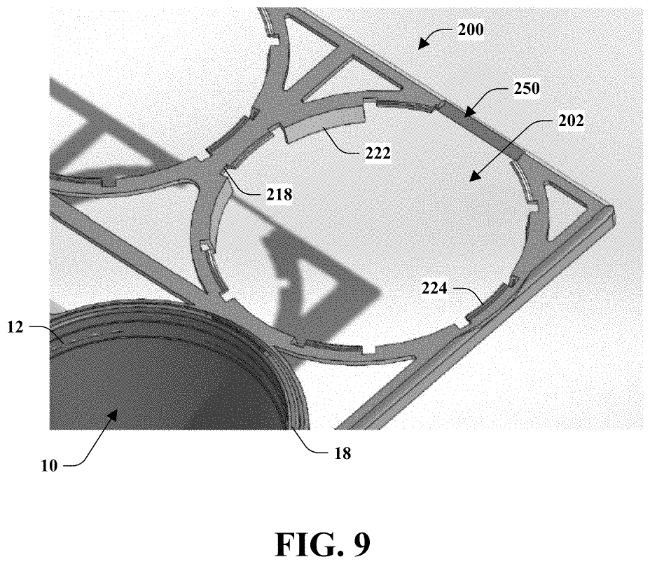

Turning to FIG. 9, a close up top view of a single opening 202 is shown. The opening 202 is defined by the hoop 216 of the tray 200. The ring 216 has a plurality of tabs 222 and 224. The ring 216 can have any suitable number of tabs 222 or 224. In the example shown in FIG. 9, the ring 216 includes five tabs 222 and six tabs 224. The tabs 222 and 224 can be oriented and spaced evenly around an inner surface of the ring 216.

In an embodiment similar to what was described with respect to the tray 1000, the rings 216 of the tray 200 can be configured with a tag slot opening 250. The tag slot opening 250 may take the form of a relief in the hoop adjacent the tag slot 15 of the planter 10 or a smaller cross-sectional size of the hoop adjacent the tag slot of the planter 10. The tag slot opening 250 can be configured to align with a corresponding tag slot 15 of a corresponding planter 10. A tag slot 15 for the planter 10 can be designed for receiving and holding a display tag that hangs from the upper rim 12 of the planter 10.

The tag slot opening 250 can be configured to accommodate features of the tag slot 15 of the planter 10 and/or the tag so that the planter 10 with the tag can be inserted into the tray 200 or the tag may be inserted into the planter's 10 tag slot 15 after the planter 10 is inserted into the tray 200. For instance, the tag slot 15 of the planter 10 can be aligned with the tag slot opening 250 of the tray 200 so that the planter 10 adequately fits into the opening 202. The tag slot 15 and corresponding tag slot opening 250 can also prevent the planter 10 from rotating relative to the tray 200. In one embodiment, the tag slot 15 and the tag slot opening 250 face an adjacent perimeter wall 206, 208, 210, 212 of the tray 200 so that the tag is visible to an observer or a scanning device. In one embodiment, the planter 10 has a through opening (e.g., a second tag slot 15) and the tray 200 has an upwardly projecting member that fits into the opening to reduce movement of the planter 10 relative to the tray 200. The upwardly projecting member may not limit upward movement of the planter 10 relative to the tray 200 or may have a shape, detect, or barb to reduce upward movement of the planter 10 relative to the tray 200. Reduced movement or rotation of the planter 10 can help to mitigate damage to any plants that are planted in the planter 10 and/or mitigate the tags from facing inward so that is block from being visible by another of the planters.

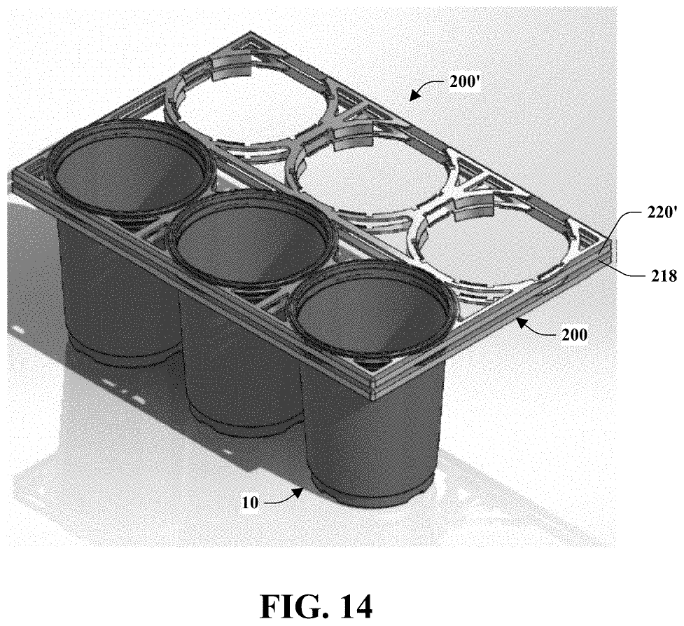

Turning to FIG. 14, a plurality of the trays 200 are stacked on top of one another. As illustrated, the top surface 218 of the first tray 200 abuts the bottom surface 220′ of the tray 200′ so that the subjacent tray supports the tray placed thereon. Although only two trays are illustrated in stacked relationship, any number of trays 200 may be present in this stacked arrangement. One will appreciate the many advantages of the stacking capabilities of the tray 200. For instance, the trays 200 and 200′ can be stacked closely together, thereby mitigating necessary storage space needed to store or ship a plurality of the trays 200. In an example, the trays 200 and 200′ can be stacked upon one another while the planters 10 are installed in the openings 202 of the tray 200. Planters 10 in one tray 200 will nest within planters 10 of the adjacent underlying tray. With the planters 10 installed in the trays 200, the trays 200 can still be stacked close together to create a small and compact shipping footprint for both the trays 200 and the planters 10. This not only makes shipping and storage of the trays 200 with planters economical 10, it facilitates automated assembly of the trays 200 and planters 10. More specifically, planters 10 may be inserted (by hand or by automation) into the trays 200 at a central facility such as a manufacturer instead of at customer (e.g., grower) facilities, as is the case with convention trays and planters that are stacked separately for shipping since the conventional trays prevent the planters from nesting.

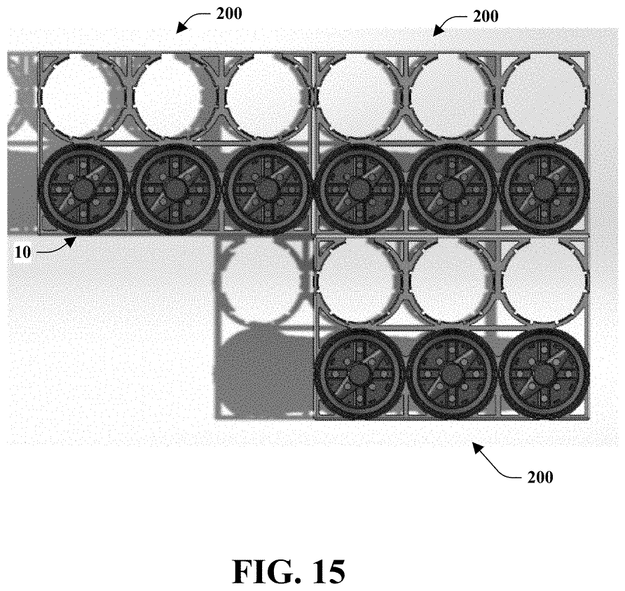

FIG. 15 illustrates three trays 200 oriented adjacent to one another. The trays 200 can be located next to one another and can, optionally, be joined at one or more perimeter surfaces to keep the trays 200 together. For example, when transporting the trays 200 or when filling the planters 10 with soil the trays 200 may be joined. The trays can be removeably attached to one another via any suitable connecting clips or coordinating interlocking members on adjacent trays 200.

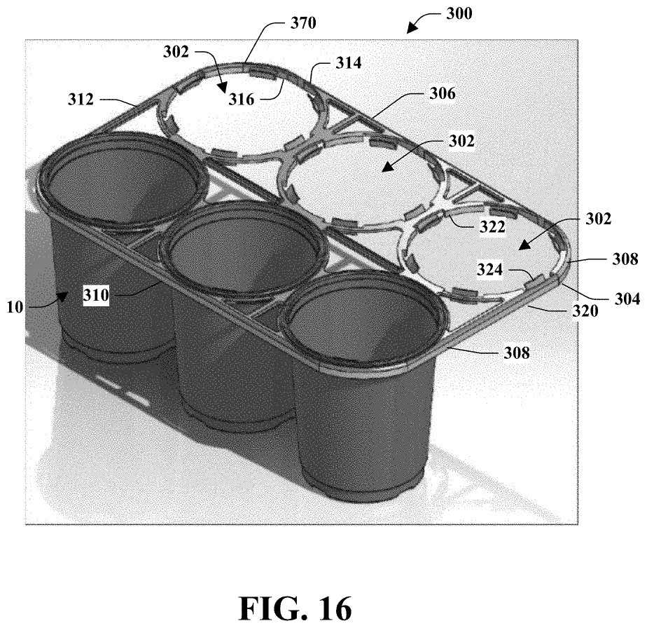

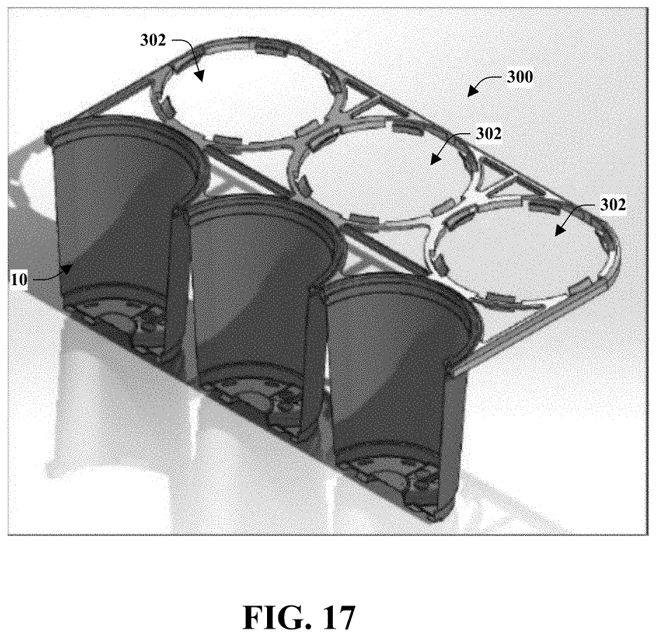

Turning to FIGS. 16-19, a tray 300 for a horticultural container 10 is shown. The tray 300 is substantially the same as the above-referenced trays 100 and 200, and consequently the same reference numerals but indexed by 100 are used to denote structures corresponding to similar structures in the trays. The foregoing description of the trays 100 and 200 are equally applicable to the tray 300 unless expressly noted herein.

As illustrated, the tray 300 can include a body 304 containing the plurality of openings 302. The body 304 can be formed by a plurality of walls 306, 308, 310, 312, forming and an outer perimeter 314. The openings 302 can be enclosed within the outer perimeter 314 and can be further defined by a plurality of hoops 316. Namely, each of the plurality of hoops 316 can define the opening 302 that extends from a top 318 to a bottom 320 of the tray 300.

The hoops 316 can include a plurality of tabs 322 and 324 that may hold the planters 10 in place. By way of example, the plurality of tabs 322 and 324 can hold the planters 10 in the openings 302 by way of snap fit, pressure fit, friction fit, interference fit, or the like.

The tray 300 can include rounded corners 370 as opposed to the 90 degree corners of trays 100 and 200, which can decrease the surface area on the top 318 of the tray 300. A decreased surface area of the top 318 can mitigate an amount of soil that can get caught on the tray 100 as described above, reduce the amount of material used, and reduce stress points that may lead to breaks in the tray 100.

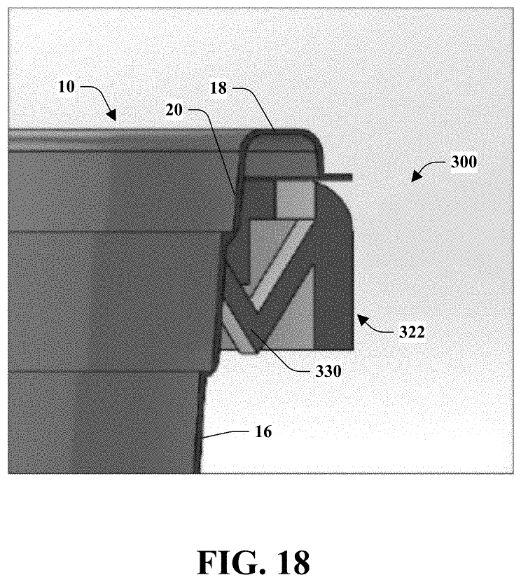

Turning to FIG. 18, an exemplary illustration of the tab 322 is shown. FIG. 18 is a close up cross-sectional view showing the interaction of the tab 322 and corresponding portions of the planter 10. The tab 322 can include a portion 330 that is “V” shaped with respect to a top surface 326 of the hoop 316. Other shapes are possible, such as an “N” shape, an “M” shape, or a “Z” shape. The portion 330 can extend, at an angle, downward from the top 318 of the tray 300 toward the bottom 320 of the tray 300 and back upward to engage the planter 10. The portion 330 can also extend radially inward from the hoop 316 in a direction toward the surface 20 of the planter 10 to hold the planter 10 in a position. It is contemplated that this shape of the tab 322 provides a spring force against the planter 10.

The rim 18 of the planter 10 can extend outward from the body 16 or the surface 20 of the planter 10 and can engage a top surface 326 of the hoop 316 to prevent downward movement of the planter 10. The shaped profile of the tab 322 can be configured to flex a suitable amount to allow for removal and installation of the planter 10 in the openings 302 of the tray 300. This can allow the planters 10 to be removeably inserted and removed from the tray 300 by a suitable force or pressure. It should be appreciated that the tab 322 can be used with the trays 100 or 200, and the tabs 322 or 324 can be used with the tray 300 without deviating from the scope of the application.

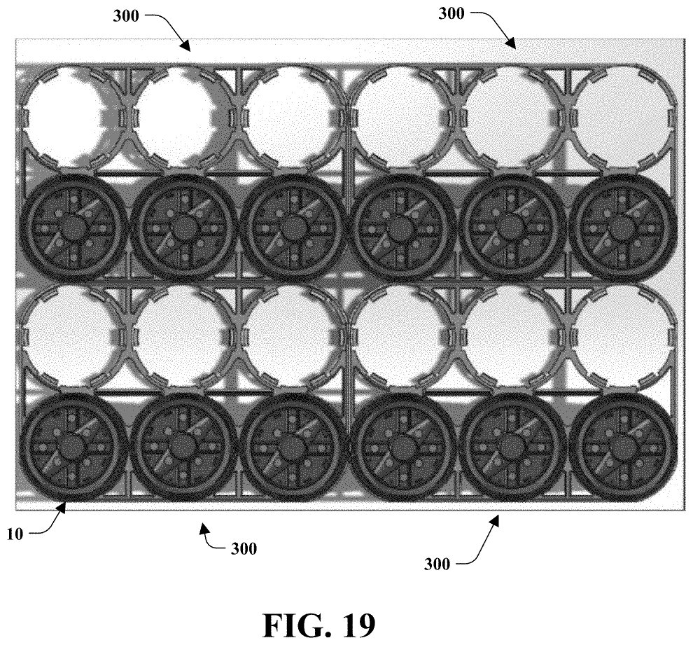

FIG. 19 illustrates a plurality of trays 300 oriented adjacent to one another. The trays 300 can be located next to one another and can, optionally, be joined at one or more surfaces to keep the trays 300 together.

Although certain embodiments have been shown and described, it is understood that equivalents and modifications falling within the scope of the appended claims will occur to others who are skilled in the art upon the reading and understanding of this specification.

What is claimed is:

1. A tray configured to hold a plurality of horticultural containers, the tray comprising:
a top surface and a bottom surface opposite the top surface;
a plurality of outer walls forming an outer perimeter;
a plurality of openings enclosed within the outer perimeter and extending from the top of the tray to the bottom of the tray; and
a plurality of hoops forming the plurality of openings, the plurality of hoops are encompassed within the outer perimeter and affixed to at least one of the plurality of outer walls, each of the plurality of openings defined by a respective hoop of the tray such that each respective hoop is configured to accept and retain a single one of the plurality of horticultural containers, and
wherein each of the hoops comprises at least one first tab, each first tab configured to engage a surface of a respective horticultural container to hold the respective horticultural container within a respective opening that is defined by a respective hoop.

2. The tray of claim 1, wherein each first tab comprises a clip at a distal end, the clip extends in a direction towards a center of the respective opening, the clip is configured to engage a top surface of a rim of the respective horticultural container to prevent upward movement of the respective horticultural container with respect to the tray.

3. The tray of claim 2, wherein at least a portion of each first tab is configured to flex between a locked and an unlocked position, each first tab configured to engage the rim of the respective horticultural container when in the locked position and configured to disengage the rim of the respective horticultural container when in the unlocked position.

4. The tray of claim 3, wherein each first tab is biased in the locked position.

5. The tray of claim 3, wherein each of the hoops further comprise at least one second tab, the second tabs different from the first tabs, each second tab configured to engage a second surface of a respective horticultural container to hold the respective horticultural container in a position relative to the tray.

6. The tray of claim 5, wherein each second tab comprises a first portion extending perpendicular and upward from a top surface of the tray such that the first portion is configured to engage a bottom surface of the rim of a respective horticultural container to support the respective horticultural container in a respective hoop, wherein the first portion mitigates movement of the respective horticultural container in a downward direction.

7. The tray of claim 6, wherein each second tab comprises a second portion extending radially-inward from each second tab in a direction towards the center of a respective opening, the second portion configured to engage an outer surface of a respective horticultural container to prevent movement of the respective horticultural container with respect to the tray.

8. The tray of claim 5, wherein each second tab holds the plurality of horticultural containers within the pluralities of hoops by way of pressure fit.

9. The tray of claim 1, wherein the tray is configured to allow for stacking with at least one other tray of similar dimensions to the first tray.

10. The tray of claim 1, wherein the plurality of hoops are configured to match a corresponding shape and size of the plurality of horticultural containers.

11. The tray of claim 10, wherein the plurality of hoops are circular.

12. The tray of claim 1, wherein the tray further comprises a plurality of secondary openings extending from the top surface to the bottom surface, the plurality of secondary openings configured to reduce soil waste by allowing soil not inserted into the horticultural container during filling of the horticultural container to pass through the secondary opening.

13. A tray and horticultural container assembly, comprising:
a tray of claim 1; and
a plurality of horticultural containers, each of the plurality of horticultural containers inserted into a corresponding single one of the plurality of openings of the tray.

14. The assembly of claim 13, further comprising a second tray wherein the first tray and the second tray are stacked one over another and the plurality of horticultural containers of each of the first tray and the second tray are configured such that corresponding feature of the plurality of horticultural containers nest within one another.

15. A tray configured to hold a plurality of horticultural containers, the tray comprising:
a plurality of hoops defining a plurality of openings, the plurality of hoops are affixed to one another, each of the plurality of openings defined by a respective hoop of the tray such that each respective hoop is configured to accept and retain a single one of the plurality of horticultural containers,
wherein each of the hoops comprise at least one a first tab, each first tab configured to engage a top surface of a rim of a respective horticultural container to mitigate upward movement of the respective horticultural container with respect to the tray; and
wherein each of the hoops comprise a at least one second tab, each second tab configured to engage a side surface of the respective horticultural container to mitigate lateral movement and to engage a bottom surface of a rim of the respective horticultural container to mitigate downward movement of the respective horticultural container with respect to the tray.

16. The tray of claim 15, wherein each first tab comprises a clip at a distal end, the clip extends in a direction towards a center of a respective opening, the clip is configured to engage the top surface of the rim of the respective horticultural container.

17. The tray of claim 15, wherein at least a portion of each first tab is configured to flex between a locked and an unlocked position, each first tab configured to engage the top surface of the rim of the respective horticultural container when in the locked position and configured to disengage the rim of the respective horticultural container when in the unlocked position.

18. The tray of claim 15, wherein each second tab comprises a first portion extending perpendicular from a top surface of the tray such that the first portion is configured to engage a bottom surface of the rim of the respective horticultural container to support the respective horticultural container in a respective hoop, wherein the first portion of each second tab mitigates movement of the respective horticultural container in a downward direction.

19. The tray of claim 18, wherein each second tab comprises a second portion extending radially-inward from each second tab in a direction towards the center of a respective opening, the second portion configured to engage an outer surface of a respective horticultural container to prevent movement of the respective horticultural container with respect to the tray.

20. The tray of claim 15, wherein the plurality of hoops are configured to match a corresponding shape and size of the plurality of horticultural containers and the tray is configured to allow for stacking with at least one other tray of similar dimensions to the first tray.

21. A tray for horticultural containers comprising:
a top surface and a bottom surface opposite the top surface;
a plurality of outer walls forming an outer perimeter; and
a plurality of openings enclosed within the outer perimeter, wherein the plurality of openings extend from the top of the tray to the bottom of the tray, the plurality of openings each configured to accept and retain a single one of the horticultural containers with a portion of the horticultural container above the tray and a portion of the horticultural container below the tray.

22. The tray of claim 21, each opening formed by a hoop of material of the tray.

23. The tray of claim 22, wherein each hoop has one or more tabs configured to engage a surface of the horticultural container to hold the horticultural container in the opening relative to the tray.

24. The tray of claim 23, wherein the tray further comprises a plurality of second tabs different from the plurality of first tabs, the plurality of second tabs configured to engage a second surface of the horticultural containers to hold the horticultural containers in a position relative to the tray.

25. The tray of claim 24, wherein the plurality of first tabs and the plurality of second tabs hold the horticultural containers in the position by way of pressure fit.
